(19) United States
(12) Patent Application Publication
(10) Pub. No.: US 2012/0282052 A1
(43) Pub. Date: Nov. 8, 2012

(54) DEVICE FOR DRILLING A COMPLEX PANEL

(75) Inventor: Sebastien Boria, Toulouse (FR)

(73) Assignee: AIRBUS OPERATIONS (S.A.S), Toulouse (FR)

(21) Appl. No.: 13/511,573

(22) PCT Filed: Nov. 25, 2010
(86) PCT No.: PCT/FR10/52525

§ 371 Date: Jul. 26, 2012

(30) Foreign Application Priority Data
Nov. 26, 2009 (FR) 0958395

(51) Int. Cl. B23B 49/02

(52) U.S. Cl. 408/3

(57) ABSTRACT

The invention relates to a device for drilling and/or boring large complex panels. Said device comprises:
a template positioned and fixed with respect to said panel;
an effector (40) able to communicate to a tool a rotary cutting movement and an advance movement, which can be described according to at least 3 linear axes and 2 rotary axes relative to a reference point attached to the effector, referred to as the effector origin;
means able to position the effector origin relative to the panel comprising relative locking of the template and the effector.

The invention relates to a device for drilling and/or boring large complex panels. It finds its application each time that this type of machining must be carried out with a positioning accuracy less than approximately 1/5000^{th} of the panel's smallest dimension, and in particular in aircraft construction.

‘Complex panel’ means a double-curvature panel whose surface substantially describes an ellipsoid portion, even a more complex shape, but whose concavity remains oriented in the same direction over the entire surface of the panel. In aeronautics this type of panel covers a surface area that can go up to several tens of m² for an envelope volume that can reach several m³. The radii of curvature are several meters to several tens of meters. The accuracy required for positioning a drilling hole on such a panel is generally between 0.2 and 0.5 mm.

Such a panel is said to be non-developable, i.e. its surface cannot be projected onto a plane keeping the distances between points on the surface.

There are basically two methods for drilling at a specific point on such a surface.

The first consists of using a machining tool whose workspace is substantially equal to that of the panel's envelope volume. Such a machine is formed of a spindle, able to receive a tool and communicate a cutting movement to this tool. The spindle is moved inside the workspace through a set of linear and rotary axes according to serial, parallel or combined kinematics. Inside the workspace, the location of the spindle is referenced in position and orientation at each point relative to a machine origin by means of position sensors generally placed on the axes of movement.

The panel is placed in the machine's workspace and its position is measured in said workspace. As the panel's position and shape is known, generally through its digital definition, one deduces from this the position of each drilling hole in the space of the machine which moves from one drilling hole to the next making sure of the tool's position and orientation. Such a method is described, for example, in patent applications EP1644135/U.S. Pat. No. 7,507,056 and EP1569058/U.S. Pat. No. 7,168,898 in the name of the applicant. However, this method is complex to implement and does not generally permit the required positioning accuracy to be obtained. In effect, the positioning accuracy of the tool on the panel is due to the combination of the positioning and movement accuracy of each axis over its entire course, the accuracy of the measurement of the panel's position and orientation in the tool's reference space and the variance between the panel's realization and its theoretical definition. Yet, for the machine-tools generally used in mechanics, in the tool's workspace each of these contributions is of the same order of magnitude as the positioning accuracy required. Moreover, this method requires a machine and tools that are large-sized. It is thus necessary to use means and machines that are high-precision and large-sized, therefore especially expensive.

Another method, used more specifically in assembly, consists of using a template. This template is placed on the panel's surface, thus defining the relative position of the patterns (holes) it reproduces. The distance between two patterns is given by the template and the accuracy of this relative positioning comes from the intrinsic accuracy of the template. A machine, preferably portable, is used to perform the machining; this machine is positioned on the panel using the template. For example, the template is in the form of flexible metal strips, narrow with respect to the curvature radii of the panels, pierced with holes giving the locations of the drilling holes. By clamping said strip onto the panel, the center-to-center distances between the holes are strictly adhered to. The drilling hole is oriented visually, normal to the surface, by the operator using the portable tool for small drilling diameters. Given the very large radii of curvature relative to the diameters of the drilling holes to be produced, this mode of orientation is generally sufficient if the operator is experienced. This method therefore gives good relative positioning accuracy between the drilling holes produced using the template's patterns. Specific measurement means must be used to position the template on the panel

When the drilling/boring diameter is large or if the drilling/boring method uses the technique of orbital drilling, or if the machine's weight or power become significant, preferably a template is used in the form of a thick, rigid drilling grid, whose shape reproduces the panel's curvature in the drilling area and which is pierced by centering holes able to receive a centering device generally located on the portable machine's nose. Thus the template plays a role in transferring the machining forces and weight of the machine. International patent application WO2008101873 in name of the applicant describes the use of such drilling grids in assembly.

According to this last embodiment of the prior state of the art, the curvilinear distance separating two drilling holes is always given by the template; however, the curvature of said template can be different from the curvature of the panel due to manufacturing tolerances of said panel and said template. This curvature difference creates two errors:
an error in the location of drilling holes;
an error in the drilling hole's direction relative to the normal to the panel's surface;

In the light of the radii of curvature involved, the first error is negligible. In contrast, the normal error can have a significant impact on the quality of the drilling carried out, especially if said drilling is performed using orbital drilling as described, for example, in patent EP1397224.

Therefore a method and a device are needed that will enable, in particular, the correction of drilling normals when a rigid template is used.

To remedy the deficiencies of the prior state of the art, the invention relates to a device for drilling or boring a complex-shaped panel comprising:
a template positioned and fixed relative to said panel;
an effector able to communicate to a tool a rotary cutting movement and an advance movement, which can be described according to at least 3 linear axes and 2 rotary axes relative to a reference point attached to the effector, referred to as the effector origin;
means able to position the effector origin relative to the panel comprising relative locking of the template and the effector.

Thus, the device of the invention uses the advantages of the drilling template and, through the effector's 5 axes of movement, allows the defects in the normal to be corrected.

Advantageously, the advance movement is communicated to the tool by a closed kinematic chain. This configuration allows precise movements to be communicated to the tool, in particular according to small alternative movements along several axes, necessary for producing bores including a correction to the normal according to the orbital drilling technique.

In order to automate the correction to the normal, the effector comprises a sensor able to measure the distance and the orientation of the panel's surface relative to the effector origin. Thus, the operator just has to lock the effector in the template and the correction to the normal is calculated based on information from the sensor.

Advantageously, the effector comprises a centering device and the template comprises a bore, which works with the centering device to position the effector origin with respect to the panel. This embodiment is compatible with using drilling grids of the prior state of the art, and therefore allows the latter to be enhanced simply by changing the effector.

Advantageously, the effector communicates the advance movement to the tool by a “Gough-Stewart platform” type of kinematic. This type of closed kinematic chain allows the whole kinematic, with 6 degrees of freedom, to be housed in a small volume and thus produce a portable effector with a low enough weight to be used in a template. To this end, the effector's weight is advantageously less than 10 kg.

By allowing the normal to be corrected, the device that is the subject of the invention enables templates to be used whose curvature is significantly different from the panel's curvature at the place where the drilling must be done, or even to systematically use a rectilinear template. Thus, the cost and the number of templates needed are greatly reduced.

According to one particular embodiment, the template comprises a rail fixed with respect to the panel and means able to guide and measure the effector's movement along this rail. According to this embodiment, the same template can be used for different panels or different sets of drilling holes on the same panel, whatever the center-to-center distances. The device's versatility can be further improved when the template comprises a second rail perpendicular to the first and means able to guide and measure the effector's movement along this rail. As a result, the template covers a larger working range and requires less repositioning on the panel's surface to perform all the drilling.

The invention will now be described more precisely in the context of preferred non-limiting embodiments shown in FIGS. 1 to 12 in which:

FIG. 1 represents a perspective view of a double-curvature panel,

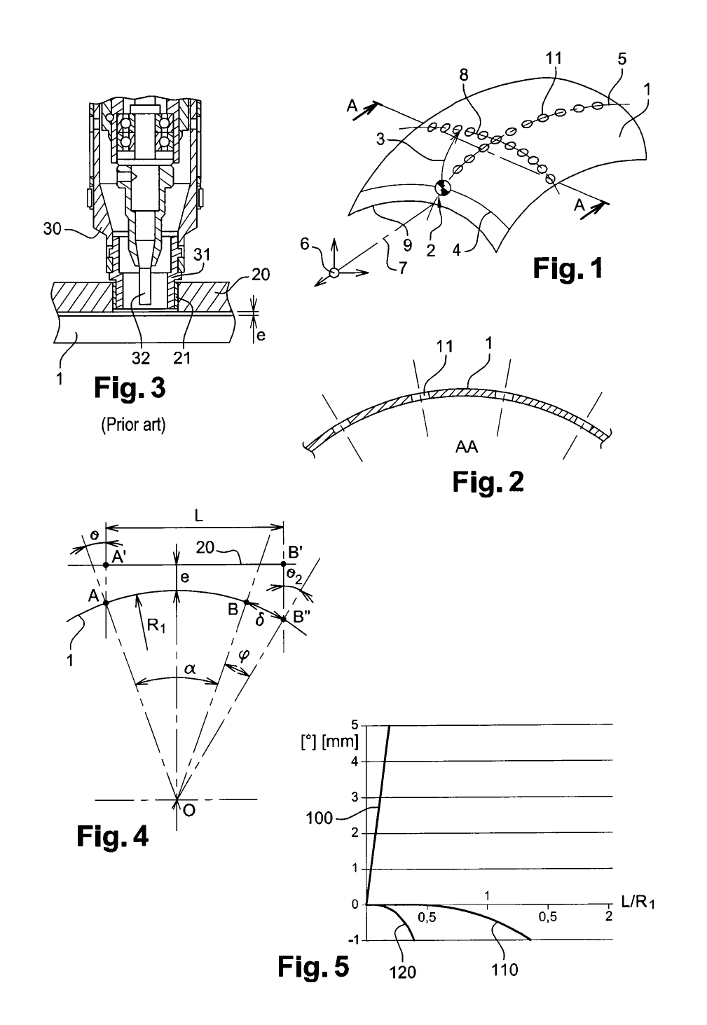

FIG. 2 shows a cross-section view of such a panel and the drilling holes produced by the device that is the subject of the invention,

FIG. 3, relative to the prior state of the art, shows the configuration of an orbital drilling device using a template,

FIG. 4 is a geometric diagram of the panel and the template,

FIG. 5 shows a chart presenting the changes in various parameters characterizing the production accuracy of a bore on a double-curvature panel,

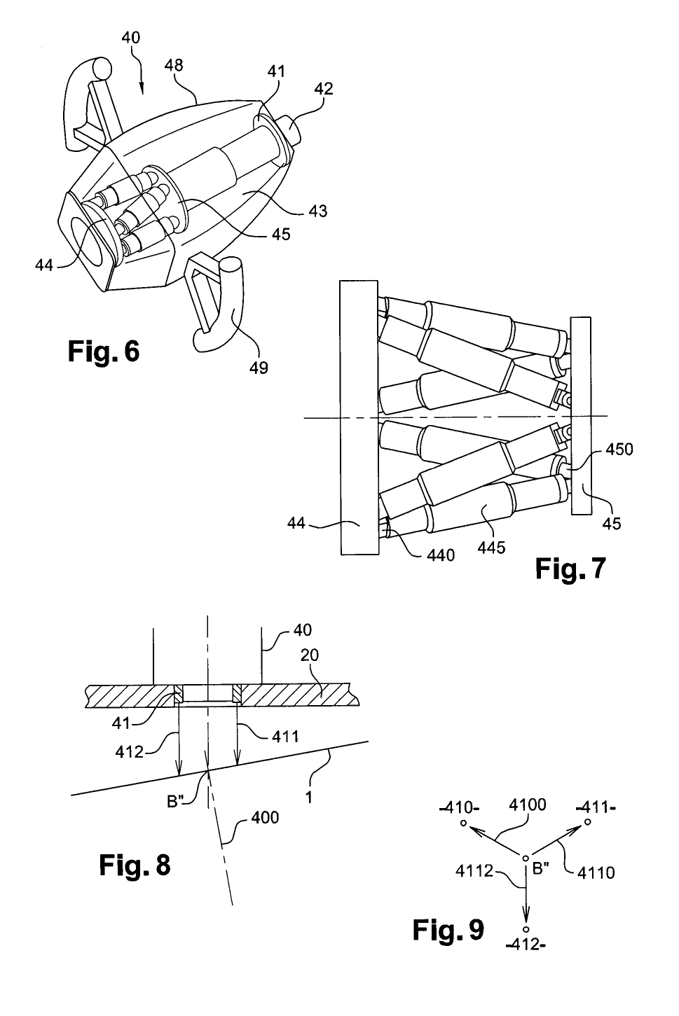

FIG. 6 is a cut-away perspective view of the effector of the device according to the invention,

FIG. 7 represents in a front view a closed chain kinematic module used to communicate the advance movement to the tool in an example of an effector according to the invention,

FIG. 8 is a detailed front view of the template, nose of the effector and panel,

FIG. 9 shows, schematically, the measurements made to determine the drilling axis,

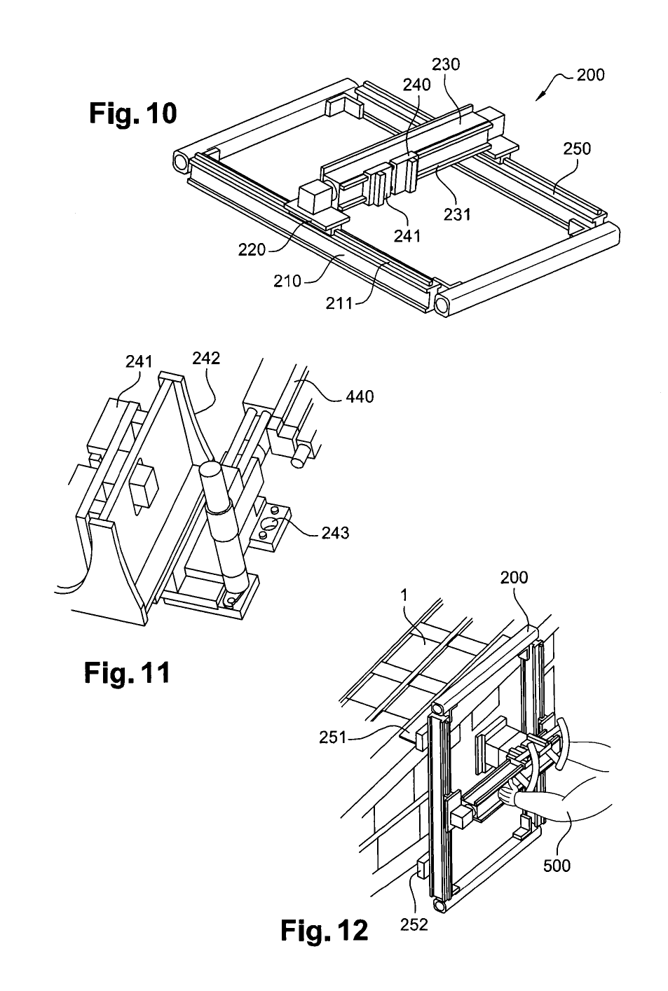

FIG. 10 is a perspective view of a template known as a digital template,

FIG. 11 represents a detail of the effector's connection to the digital template,

FIG. 12 is a perspective view in position of an example of the device according to the invention.

FIG. 1: the invention is designed to perform machining, in particular drilling/boring (11) on a complex panel with a changing double curvature (1). The position of each bore is defined on the digital model of said panel by a curvilinear vector (3) connecting a panel origin (2) to the theoretical center of the bore. This curvilinear vector is uniquely defined on the surface of the digital model by the geodesic line connecting the origin and center of the bore. If the bores must be produced using a machine tool whose workspace is able to encompass the panel's envelope volume, then, to position said bore, it is necessary to determine the position of the panel origin (2) in the machine's space via the intersection of two geodesic lines (4,5) passing through said origin; determine the vector (7) connecting the machine origin (6) and part origin (2); then identify said corresponding geodesic lines (4,5) on the digital model; determine, for the center of each bore, the curvilinear vector (3) connecting it to the part origin of the digital model; translate this vector into Cartesian coordinates and translate these coordinates into movements of the machine's axes after having changed the reference point between the part reference point centered on the part origin (2) and the machine reference point centered on the machine origin (6). During these operations, the measurement and movement uncertainties combine. In addition, the actual shape of the panel does not correspond exactly to its theoretical shape as described in its digital model. This variance, not constant over the surface and commonly reaching several millimeters, is due to the manufacturing uncertainty of said panels' production methods. Concerning non-developable surfaces, the path corrections necessary to take these variances into account make use of complex algorithms and require additional approximations. When the machining to be performed on such a panel is limited to drilling and boring holes, it is more advantageous and there is greater precision when drilling templates (20) are used. Such templates are usually fixed to the panel by riveting or suction pads. They are positioned by direct measurement on the panel. For example, a template following a drilling line (8) is positioned parallel to the panel's edge (9); this forms, as an example, an assembly interface with another panel. Alternatively, the template can be placed parallel to a drilling or riveting line already realized. Parallelism means an equal curvilinear distance from two end points of the template relative to the material reference element, such as the edge (9) of the panel, the distance being measured over geodesics locally perpendicular to the reference element and connecting the ends of the template. These distances can be easily calculated by an experienced operator with a flexible ruler pressed onto the surface of the panel, with a precision almost equal to that obtained by reconstructions and transfers. Alternatively, if greater precision is required, this intuitive positioning can be supplemented by positioning obtained by measurement using a “laser tracker” type of measuring device. Such equipment is known to the person skilled in the art and distributed, for example, under the brand name FARO® or LEICA®. According to this method:
the template is pre-positioned intuitively as described above;
a target is placed against the reference element at two extreme points and the positions in space of these points are measured by the tracker;
the target is then placed at the two ends of the template and the corresponding positions of the points in space are measured;
the two lines' distance and orientation in space are calculated and compared with the theoretical values and, if necessary, the template is moved slightly to correct the variances.

Of course, it is possible to use more complex methods. The center-to-center distance between the different bores is then given directly by the template.

FIG. 3: according an example of the prior state of the art, the template (20) is in the form of a rigid drilling grid, placed at a small distance (e) from the panel's surface and pierced with calibrated bores (21) into which the nose (31) of a portable drilling/boring machine (30) fits. In this example the portable machine (30) is of a type able to carry out the drilling/boring operation by a method known as orbital drilling. This method consists of using a milling tool (32) with a smaller diameter than that of the bore to be produced, and moving this tool along a helical path with an axis normal to the surface to be drilled. Thus, with the same tool it is possible to produce bores with very different diameters simply by changing the radius of the helical path.

The normality condition of the axis is given directly by the orientation of the bore (21) in the drilling grid (20). When the panel is curved and the grid used is thick and rigid, the grid must therefore have the same curvature as the panel at the position where it is placed. However, as already indicated, the actual shape of the panel is different from its theoretical shape, and the production of the grid is also subject to the accuracy of the manufacturing means. Finally, the grid's positioning on the panel is also subject to inaccuracies. Since the curvature changes, these inaccuracies directly affect the correspondence between the grid's curvature and the panel's curvature and, as a result, the orientation of the centering bore (21) relative to the normal to the panel's surface.

FIG. 4: without claiming any mathematical demonstration or theory, the difference in curvature between the template (20) and the panel (1) has an impact on the location of the bores, in particular respecting the center-to-center distances between the holes, and on the drilling direction, which must be normal to the panel's surface. In this example, the drilling template (20) is flat and the panel that is the subject of the drilling operation has a constant curvature with radius R1. The drilling holes are to be produced on the panel at points A and B. The course from A to B on the panel's surface corresponds to an angular sector a according to the curvature of the panel (1) and a curvilinear length R1.α.

The drilling template is placed at a minimum distance from the panel (1). The centering bores corresponding to drilling holes A and B are located on the template at points A′ and B′ respectively and are separated by a center-to-center distance L such that L=R1α. The template is placed such that the axis of the bore corresponding to point A′ projects to point A on the panel (1) normal to the plane of the template (20). If the drilling is done at A using this template and with the means (30) of the prior state of the art, the axis of the hole thus produced would not be normal to the panel's surface and would present an angular variance θ relative to this normal. Because of the curvature difference between the template (20) and the panel (1), the drilling performed with the means of the prior state of the art (30), by being centered on bore B′, will be separated from the theoretical point where the hole centered on B is to be produced by curvilinear distance δ. This drilling hole will also present an angular fault θ2 between the normal to the panel at the drilling point and the direction of the hole produced.

FIG. 5 shows the changes (100) in the normal error (θ2) as a function of the ratio of the center-to-center distance (L) of the holes to the radius of curvature (R1). It shows, qualitatively, that even when the panel's local radius of curvature is very large the normal error very rapidly becomes significant and unacceptable. For this reason, the drilling grids or templates according to the prior state of the art are produced with the greatest care and adapted to the panel's actual curvature at each area requiring machining.

FIG. 5 also gives the qualitative change (110) in the location error (δ) of the hole corresponding to point B on the panel and produced by centering the drilling means of the prior state of the art (30) in the bore corresponding to point B′ of the template. This error remains very small, even for center-to-center distances reaching values comparable to half the radius of curvature, i.e. covering an angular sector of 30° at the panel's surface.

Lastly, FIG. 5 gives the qualitative change (120) in the normal error φ of a bore that should be produced at point B″ according to this bore's theoretical orientation at point B.

The holes drilled in the panels are generally for installing rivet types of fasteners. Producing a bore intended to receive a rivet whose axis in not normal to the surface has an impact on the quality and mechanical strength of this assembly. As the bearing surface of the rivet head is no longer parallel to the surface it is difficult to install a uniform tension in the fastening. While this fault can be at least partially compensated for by spot-facing, the alignment fault will then lead to the rivet head not being perfectly flush; in addition to the unaesthetic appearance, this will result in increased aerodynamic drag on an aircraft. In addition, orientation errors in the drilling holes do not allow any attempt at what is known as a mechanical assembly of the panels thus drilled.

FIG. 6: the device according to the invention comprises an effector (40) able to communicate to the tool an advance movement, which can be described according to at least 3 linear axes and 2 rotary axes. The 3 linear axes allow a helical path to be communicated to the tool for carrying out orbital drilling. The two rotary axes make it possible to compensate for the angular fault between the orientation given to the machine by the drilling template and the normal to the surface of the panel that is the subject of the drilling operation. The effector (40) comprises a housing (48) connecting a centering device (41) at one end and a base (44) at the other end. The housing comprises handles (49) to make it easier for the operator to grasp the effector. The centering nose (41) is able to be introduced in a bore in the template positioning the effector relative to the part.

The base (44), fixed relative to the housing (48) and therefore relative to the centering nose (41) of the effector, is connected to a platform (45) by a kinematic mechanism known as a Gough-Stewart mechanism comprising 6 jacks (445), FIG. 7, connected by joints (440) at the first end to the base (44) and at the other end (450) to the platform. These 6 jacks can be controlled individually and extended axially. The extension of the jacks means the platform (45) can be moved relative to the base (44) by 6 degrees of freedom. This kinematic device forms a closed kinematic chain, i.e. regardless of the platform's movement at least 2 jacks must be extended. This provision allows the movements to be controlled in a precise way, including by small movements, by freeing it from friction and hysterisis phenomena in the kinematic chain. This kinematic makes it possible to thus have 6 axes of movement in an extremely small volume and great mechanical rigidity along all the axes of movement.

The jacks can be of different kinds, preferably electric jacks using ball screws.

A spindle (43) is fixed to the platform (45). It can be pneumatic or electric and transmits the cutting movement to the tool mounted in the tool-holder (42) that extends said spindle.

Through the action of the jacks (445), the spindle, and therefore the tool, can be moved in all the directions of the space, thus making possible a helical path whose axis does not necessarily match the axis of the centering device (41). The electronic control module can be integrated in the effector or placed outside it. In this case, the control module is connected to the effector by a control bus.

Alternately the effector can comprise a command interpreter, a memory, and a radio communication device, when a calculation and command generation module is installed outside the effector. For each drilling hole, the effector sends information about the geometry to be realized and its position to the command generation module, based on this information, the generation module calculates a movement program comprising the corresponding movement instructions for each jack (445), these instructions are stored in the memory of the effector, which interprets them in order to carry out the machining.

The geometry of the machining to be carried out consists essentially of defining the position and orientation of the drilling axis or the helical path in the case of orbital drilling. A first embodiment assumes that the curvature of the template (20) is known and advantageously that this is rectilinear and consists of locating the machining axis at point B″ corresponding to the intersection of the centering device's axis with the panel's surface. The position of this point can be estimated by the theoretical distance (e) separating the template (20) from the panel. The orientation of the machining axis is taken to be equal to the theoretical inclination orientation (α/2, FIG. 4) of this axis relative to the axis of the centering device. This method induces a normal error (φ), which, however, remains acceptable while the drilling performed according to this method covers an angular sector of curvature of about 10°, given the radii of curvature involved, this can be sufficient in many cases.

FIG. 8: in order to determine the geometry of the machining more precisely, the effector (40) comprises one or more sensors (410,411), preferably housed in the centering nose (41), whose measurements make it possible to determine the distance to the surface of the panel (1), the position of point (B″) of the intersection of the axis of the centering device (41) with the surface of the panel (1) and the relative orientation of the normal to the panel at this point with respect to the axis of the centering device.

FIG. 9: as an example, it is possible to use 3 distance sensors (410, 411, 412) distributed over the same diameter of the circumference of the centering device (41). These sensors can be mechanical, optical or electrical. As the distance between each of the measurement points of said sensors and the end of the centering device (41) is known, a good approximation of the position of point B″ is obtained by calculating the position of the center of the circle passing through these three points. A good approximation of the normal to the surface of the panel at this point is then obtained by calculating the pairwise vector products between the vectors (4100, 4110, 4112) connecting the measurement points to the center (B″) of this circle and averaging the 3 results.

Based on these indications the tool's path around the optimized drilling axis (400) is calculated.

Thus, using this device it is possible to correct the problem of the normal to the surface and eliminate the error between the normal to the surface and the axis of the centering device, i.e. θ2, and to eliminate the error, φ, between the direction of the theoretical normal to the drilling point and the actual normal to the point where this drilling is actually done, using a template whose curvature differs significantly from the panel's curvature. These configurations enable significant reductions in the cost and number of templates needed for drilling a complex panel.

Advantageously, this possibility of correcting the normal to the panel's surface relative to the orientation given to the effector (40) by the template (20) allows rectilinear templates to be used that are easy to produce. The device of the invention allows rectilinear templates to be used, including for relatively tight radii of curvature (several hundred millimeters) whenever the curvilinear length of the line on which the drilling is done does not exceed the length corresponding to an angular sector of 30° of a curvature with this radius. Such a template can be fixed to the panel by any means, including non-material means, that ensure a fixed relative position and orientation of the template relative to the panel to be machined.

FIG. 10: this advantage can be put to use to produce so-called digital drilling templates (200). Such a template comprises a reference rail (210) provided with a measurement track (211) along which a carriage (220) slides. The measurement track (210) allows the position of the carriage (220) to be precisely located at any point on the reference rail (210). The carriage (220) able to slide along the reference rail (210) comprises a device for locking in position on said rail and advantageously supports a second rail (230), which also has a measurement track (231), perpendicular to the reference rail. A carriage (240), whose position is known at any point thanks to the measurement track (231) associated to the second rail, slides along this second rail; this carriage also has a device for locking in position and bears a bracket (241) on which a connecting part (242) can be accommodated, comprising a bore (243) able to receive the nose of a portable drilling machine (440), FIG. 11. This drilling machine can consist of the effector (40) according to the invention. Alternatively, the template can comprise only a single rail (210). The effector is then fixed to the first carriage (220). When said template (200) comprises a device with cross-slide carriages along two orthogonal rails (210,230), it advantageously comprises a third rail (250), not used for positioning or measurement, whose function is simply to support the end of the second rail (230).

FIG. 12: the template (200) is fixed and positioned on the panel to be machined (1) by suitable means (251,252). The operator (500) installs the effector according to the invention (40) in the bore (243), then it is moved from one hole to be made to the next by sliding the carriages (220,240) and the movements are shown on a display (not shown), using the information given by the measurement tracks (211,231). At each drilling point the carriages are locked on the rails. The effector's sensors (410, 411, 412) measure the normal to the surface and the position of the center of the bore, the movement commands for the drilling are deduced from this and the drilling is carried out. In this way a single drilling template covers a very large range of configurations, which makes it possible to benefit from the advantage of this method in the positioning accuracy of the bores without the constraint of producing many templates for controlling the normal errors.

The above description clearly illustrates that, through its various features and their advantages, the present invention realizes the objectives it set itself. In particular, it allows drilling normals to be corrected when a rigid template is used associated with a portable drilling unit.

1. Device for drilling or boring a complex panel (1) characterized in that it comprises:
a template (20,200) positioned and fixed with respect to said panel (1);
an effector (40) able to communicate to a tool a rotary cutting movement and an advance movement, which can be described according to at least 3 linear axes and 2 rotary axes relative to a reference point attached to the effector, referred to as the effector origin;
means (21, 211, 231) able to position the effector origin relative to the panel comprising relative locking of the template and the effector.

2. Device according to claim 1, wherein the advance movement is communicated to the tool by a closed kinematic chain.

3. Device according to claim 1, wherein the effector comprises a sensor (410, 411, 412) able to measure the distance and the orientation of the surface of the panel (1) relative to the effector origin.

4. Device according to claim 1, wherein the effector comprises a centering device (41) and the template comprises a bore (21), which works with the centering device (41) to position the effector origin with respect to the panel (1).

5. Device according to claim 1, wherein the curvature of the template differs significantly from the curvature of the panel (1) at the position of the template on the latter.

6. Device according to claim 5, wherein the template (20) is rectilinear.

7. Device according to claim 2, wherein the effector communicates the advance movement to the tool by a Gough-Stewart platform type of kinematic.

8. Device according to claim 7, wherein the effector (40) weighs less than 10 kg.

9. Device according to claim 4, wherein the template comprises a rail (210) fixed with respect to the panel and means (211, 220) able to guide and measure the effector's movement along this rail.

10. Device according to claim 9, wherein the template comprises a second rail (230) perpendicular to the first and means (231, 240) able to guide and measure the effector's movement along this rail.
